(19) United States
(12) Patent Application Publication
(10) Pub. No.: US 2022/0021235 A1
(43) Pub. Date: Jan. 20, 2022

(54) DEVICE FOR EXPANDING A STANDARD LUMINAIRE WITH NO BATTERIES FOR USE AS EMERGENCY LIGHTING

(71) Applicant: STANDARD PRODUCTS INC., Saint-Laurent (CA)

(72) Inventors: Samuel RIMOIN, Saint-Lazare (CA); Edgardo MEDVEDOCKY, Lachine (CA)

(21) Appl. No.: 17/378,337

(22) Filed: Jul. 16, 2021

Related U.S. Application Data
(60) Provisional application No. 63/052,951, filed on Jul. 16, 2020.

(51) Int. Cl. H02J 9/06; F21S 9/02; F21S 4/28; F21V 23/02

(52) U.S. Cl. CPC H02J 9/065; F21S 9/022; F21Y 2115/10; F21V 23/023; H02J 9/061; F21S 4/28

(57) ABSTRACT

An emergency light system connected to a battery unit comprises a LED driver to be powered by a switched power source, a light fixture to provide light when powered, and a link driver. The link driver comprises driver connectors powered by the LED driver, battery connectors powered by the battery unit, powering connectors connected to the light fixture, and an internal transfer device adapted to switch power source powering the power connectors from the driver connectors to the battery connectors upon detection of a power outage. Also described is the link driver to retrofit a light fixture connected to a battery unit into an emergency light system.

### CROSS REFERENCE TO RELATED APPLICATIONS

This Application claims priority from U.S. Provisional Patent Application No. 63/052,951, now pending, filed on Jul. 16, 2020, which is herein incorporated by reference in its entirety.

### FIELD

The subject matter disclosed generally relates to blackout security systems. More particularly, the subject matter disclosed relates to systems to provide emergency lighting in case of blackouts.

### BACKGROUND

Blackouts during the night or in closed locations are situations wherein people, without warning, are in the dark and in need of light to appropriately respond to the situation.

For these situations, emergency lights exist. However, they need to be plugged in a power outlet. The outcome of this requirement is the need to plan additional outlets for these emergency lights, or the use of existing outlets that are not is the best location to provide lighting is case of blackouts.

Emergency lighting is only one component of a building's life safety system, but perhaps one of the most important. It provides a minimum level of assistance to direct the building's occupants safely out of it. Moreover, it also helps personnel and emergency responders to locate safety equipment, to perform safety instruction, or to shut down hazardous equipment or operations.

An emergency light is, in its most simple expression, a battery-backed lighting device that switches on automatically when the building experiences a power outage or when a lighting circuit fails.

Furthermore, there are mandatory requirements around emergency lighting. Emergency lighting other than emergency signs must provide an average level of illumination of 10 lux or 1 foot candle and cannot be less than 1 lux or 0,1 foot candle at floor or tread level in place such as exit ways, principal exits and routes, corridors serving the public, underground walkways, and more.

There is therefore a need for a new solution for emergency lights that address these requirements and these drawbacks.

### SUMMARY

According to embodiments, there is a present object to describe a device, aka link driver, for adapting a standard luminaire for use as emergency lighting with no batteries, and in combination with emergency battery packs.

According to embodiments, there is a present object to further describe a standard luminaire retrofitted with a device for use as emergency lighting with no batteries, and in combination with emergency battery packs.

According to embodiments, an object is to replace non-esthetic nowadays emergency lighting with the retrofitted or adapted standard lighting fixture comprising an emergency component connected to a battery unit that, upon occurrence of a power outage, will operate as an emergency lighting.

In normal mode, the lighting fixture runs on alternative current (AC) power and is lit up with full lumen output. The device utilized in this scenario, in the eventuality of a power failure, will now draw power from the battery unit. The lighting fixture will light up using direct current (DC) power. According to a realization, its wattage consumption diminishes to less than 20 Watts, less than 15 Watts, and typically to 11 Watts for 30 minutes and up to 2 hours, or even up to 4 hours or more, based on the battery capacity. The number of lumens also diminishes, but maintain the required amount as per the National Building Code. The emergency lumen output of each of lighting fixtures varies based on its specs in normal mode, aka under AC power.

According to an embodiment, there is provided a link driver to be installed in an emergency light system connected to a battery unit, the emergency light system including a light-fixture driver and a light fixture powered by the light-fixture driver. The link driver comprises: a driver connector adapted to be powered by the light-fixture driver; a battery connector adapted to be powered by the battery unit, wherein the battery unit is adapted to power the battery connector upon occurrence of a power outage; a powering connector adapted to be connected to the light fixture; and an internal transfer device adapted to switch a power source powering the powering connectors from the driver connector to the battery connector upon detection of a the power outage.

According to an aspect, the link driver is adapted to be powered by Direct Current (DC) power sources.

According to an aspect, the link driver is adapted to transmit a high-power output when powered by the light-fixture driver and a low-power output upon the detection of the power outage, the high-power output being greater than the low-power output.

According to an aspect, the low-power output enables powering the light fixture to a lighting efficiency of at least 10 lux.

According to an aspect, the lighting efficiency under low-power output is maintained for at least one of 30 minutes, 2 hours, and 4 hours.

According to an aspect, the low-power output enables powering the light fixture to maintain an average lighting efficiency that is equal or over 1 lux over a reference time period of at least 30 minutes.

According to an aspect, the low-power output is below one of 20 watts, 15 watts and 12 watts.

According to an aspect, the low-power output features a constant current over a reference time period of at least 30 minutes.

According to an aspect, the link driver comprises a PCB connecting the driver connector, the battery connector, the powering connector, and the internal transfer device.

According to an embodiment, there is provided an emergency light system, comprising: a battery unit adapted to transmit power upon occurrence of a power outage; a light-fixture driver adapted to be powered by a switch-controlled power source; a light fixture for providing light when powered; and a link driver. The link driver comprises: a driver connector adapted to be powered by the light-fixture driver; a battery connector adapted to be powered by the battery unit; a powering connector connected to the light fixture; and an internal transfer device adapted to switch power source powering the power connectors from the driver connectors to the battery connectors upon detection of the power outage.

According to an aspect, the light-fixture driver is adapted to be powered with Alternative Current (AC) and the link driver is adapted to be powered with Direct Current (DC).

According to an aspect, the link driver is adapted to transmit a high-power output when powered by the switch-controlled power source and a low-power output upon the detection of the power outage.

According to an aspect, the low-power output is below one of 20 watts, 15 watts and 12 watts.

According to an aspect, the low-power output features a constant current over a reference time period of at least 30 minutes.

According to an aspect, the constant current of the low-power output is maintained as long as voltage provided by the battery unit is over a threshold value and the power outage remains.

According to an aspect, the link driver comprises a PCB connecting the driver connector, the battery connector, the powering connector, and the internal transfer device.

According to an aspect, the light fixture includes a LED fixture.

According to an embodiment, there is provided a method of retrofitting into an emergency light system a light fixture assembly comprising a light fixture and a light-fixture driver connected to the light fixture. The method comprises: providing a link driver; mounting the link driver to the light fixture assembly; disconnecting the light-fixture driver from the light fixture assembly; connecting the light-fixture driver to the link driver; connecting the link driver to the light fixture; and connecting a battery unit to the link driver. The link driver is adapted to switch from the light-fixture driver powering the light fixture to the battery unit powering the light fixture upon a power outage.

According to an aspect, the link driver is adapted to transmit a high-power output when powered by the light-fixture driver and a low-power output upon the detection of the power outage, the high-power output being greater than the low-power output.

According to an aspect, the light-fixture driver is adapted to be powered with Alternative Current (AC) and the link driver is adapted to be powered with Direct Current (DC).

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 is a schematic of an emergency light system comprising a link driver in accordance with an exemplary embodiment;

FIGS. 2 to 4 are respectively perspective, side and top plan views of a casing enclosing a link driver in accordance with an exemplary embodiment;

FIG. 5 is a schematic of a printed circuit board (PCB) of a link driver in accordance with an exemplary embodiment;

FIG. 6 is a schematic of an electrical circuit of a link driver in accordance with an exemplary embodiment;

FIGS. 7A and 7B are block diagrams illustrating current flow and states respectively in normal condition and during blackout in the emergency light system in accordance with an exemplary embodiment;

FIG. 8 is a schematic of the installation of the link driver in a standard light fixture in accordance with an exemplary embodiment; and

FIG. 9 is a picture of a portion of the interior of a retrofitted light fixture comprising a link driver in accordance with an exemplary embodiment.

It will be noted that throughout the appended drawings, like features are identified with like reference numerals.

### DESCRIPTION OF VARIOUS EMBODIMENTS

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.”, “such as,” or the like) provided herein, is intended merely to better illuminate the exemplary realizations and does not pose a limitation on the scope of the realizations. No language in the specification should be construed as indicating any unclaimed element as essential to the practice of the realizations.

In the following description, it is understood that terms such as “first”, “second”, “top”, “bottom”, “above”, “below”, and the like, are words of convenience and are not to be construed as limiting terms.

The orientation terms “top”, “up”, “upper”, “bottom”, “lower”, “down”, “vertical”, “horizontal”, “interior” and “exterior” and the like are intended to be construed in their normal meaning in relation with normal installation of the product. According to the present description, normal installation will be construed as a ceiling installation and orientation terms will be used as such, while one may understand that other installations such as a wall installation are also intended to be covered by the present description.

It should further be noted that for purposes of this disclosure, the term “connected” means the joining of two members directly or indirectly to one another. Such connecting may be stationary in nature or movable in nature and/or such joining may allow for the flow of electricity, electrical signals, or other types of signals or communication between two members. Such connecting may be achieved with the two members or the two members and one or more additional intermediate members being integrally formed as a single unitary body with one another or with the two members or the two members and any additional intermediate member being attached to one another. Such connecting may be permanent in nature or alternatively may be removable or releasable in nature.

Referring now to the drawings, in realizations, there are disclosed an emergency light system 100, and, according to realizations, a link driver 110 adaptable to a standard light fixture 90 to retrofit the standard light fixture 90 into an emergency light system 100 adapted to face a power outage, wherein the link driver 110 is installed with or within the installation of the standard light fixture 90.

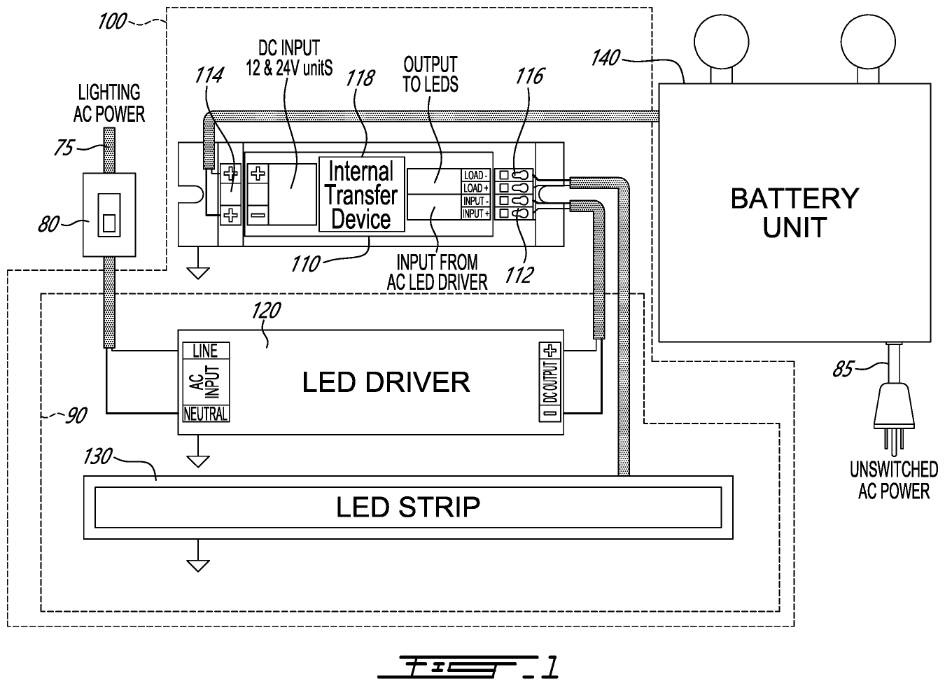

Referring particularly to FIG. 1, the emergency light system 100 is powered with an alternative current (AC) lighting power source 75, aka a switched power source 75 connected to a switch 80, itself connected to a LED driver 120 part of the exemplary standard light fixture 90. The LED driver 120 is connected to the link driver 110, wherein the LED driver 120 acts as a first power source to the link driver 110.

In parallel, a battery unit 140 is connected to an unswitched AC power source 85, charging the battery unit 140 when not in a blackout situation.

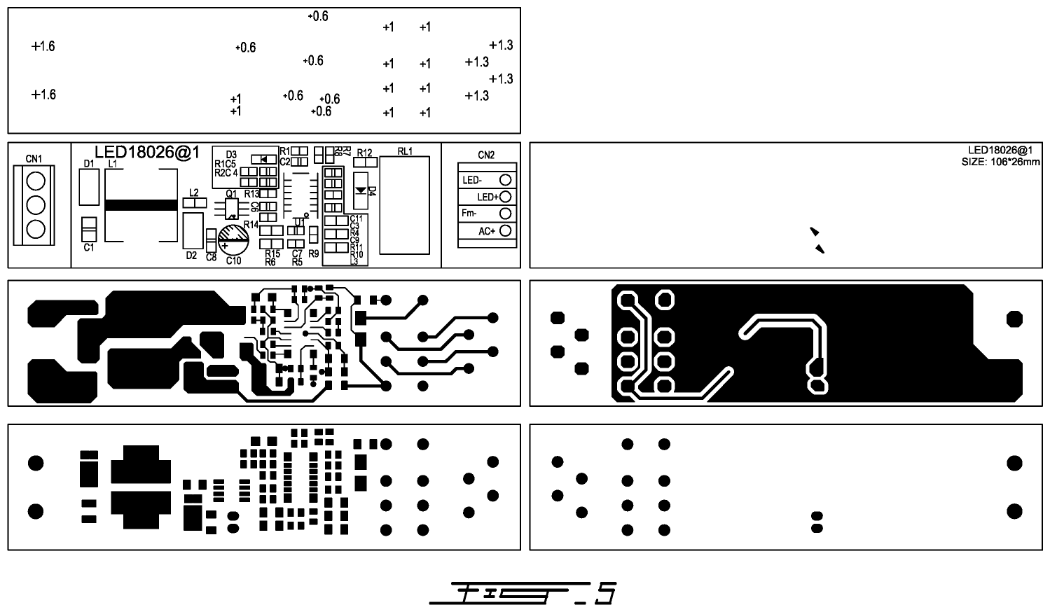

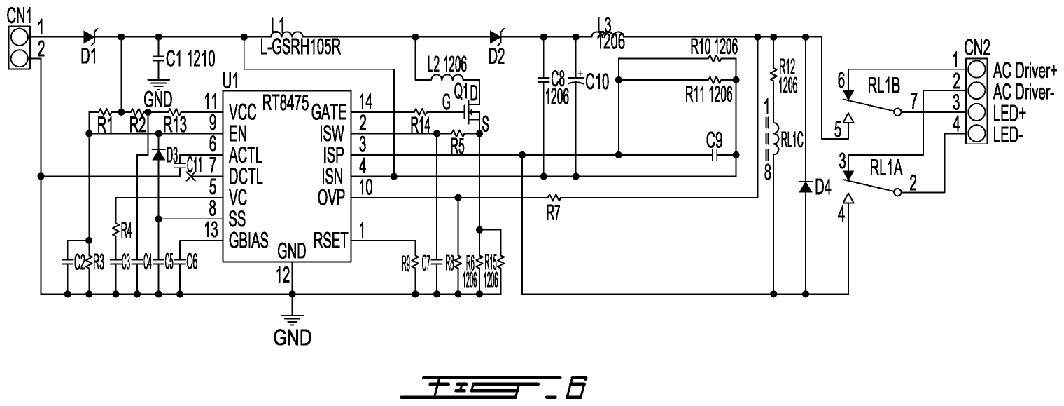

The link driver 110 is powered in direct current (DC) at its battery connectors 114 by the battery unit 140. The link driver 110 is powered by the LED driver 120 at its driver connector 112 with DC current. The link driver 110 is finally connected to the LED fixture 130, aka LED strip 130, of the exemplary standard light fixture 90, through its powering connectors 116. The link driver 110 comprises a printed circuit board (PCB) 112 (see FIGS. 5 and 6) designed to detect if current is fed by the battery unit 140, and to power the LED fixture 130 with one power source among the power from the battery unit 140 and the LED driver 120 depending on blackout situation or not.

It is to be noted that the battery unit 140, according to an embodiment, comprises a transformer (not shown) transforming the AC current into DC current that may be used to charge the battery unit 140. According to another embodiment, the transformer may be external of the battery unit 140 and integrated elsewhere, whereby the function of the battery unit 140 may be limited to be charged and to powering up the link driver 110 upon blackouts.

It is further to be noted that the battery unit 140 may power one or more link driver 110, thus one or more emergency light system 100. Use of one battery unit 140 per emergency light system 100 or use of one battery unit 140 with multiple emergency light systems 100 depends in part on physical configuration, and may involve other design factors.

Finally, the link driver 110 is designed to power the LED fixture 130 of the exemplary standard light fixture 90 during blackouts.

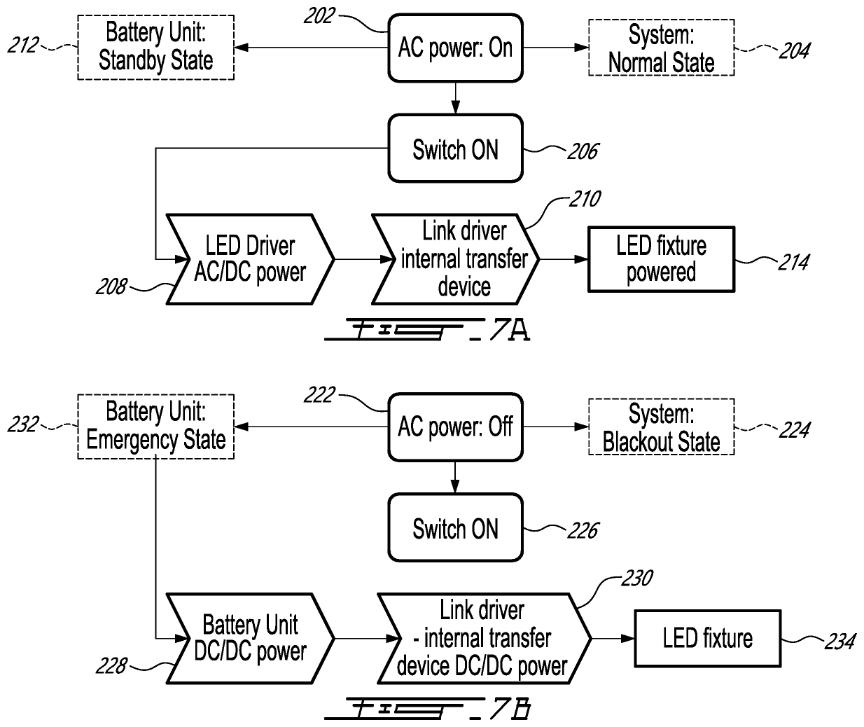

Operation of the link driver 110 is driven by the following conditions illustrated through FIGS. 7A and 7B:

Referring now to FIG. 7A and FIG. 1, when not in blackouts and when AC power is ON, aka operational (block 202), the link driver 110 is in Normal State (block 204). If the switch 80, aka wall switch, is on ON position or when turned ON, the switch 80 bridges current from the AC power source 75 to the LED driver 120 (block 206). The LED driver 120 powers the link driver 110 (block 208), with the link driver 110 powering the LED fixture 130 with high-power output through an internal transfer device 118 (block 210). The outcome in this situation being that the LED fixture 130 is powered (block 214), thus lighting up the space around the LED fixture 130. In this case, the battery unit 140 is in Standby State (block 212).

Referring now to FIG. 7B and FIG. 1, during a blackout (block 222), aka when AC power fails, the battery unit 140 passes into an Emergency State (block 232) triggered by the charging circuit being inactive. The battery unit 140 is sending battery power to the link driver 110 (block 228). The internal transfer device 118 of the link driver 110 switches the power source powering the LED fixture 130 to the battery unit 140 and controls the value of the current to a constant value regardless of the battery voltage (as long as the link driver 110 is supplied with the minimum DC voltage needed to generate the constant current), powering the LED fixture 130 with low-power output (block 230). The LED fixture 130 is thus powered (block 234), thereby lighting up the space around the LED fixture 130 during the blackout.

Referring particularly to block 230, the link driver 110, in Emergency state, receives DC power from the battery, monitors the power source and controls the value of the current transmitted to the LED fixture 130, aka provides DC/DC power control, to deliver a constant lighting and to ensure maximum duration of the emergency lighting during the blackout.

In the diagram of FIG. 7B, it is worth noting that the switch is on the ON position (block 226), but the LED fixture 130 is powered regardless of the switch position. Failure of the AC power source powering the battery unit 140 is the system condition that triggers the Emergency State, thereby triggering the lighting of the LED fixture 130 when entering in an Emergency State.

The emergency light system 100 is a solution capable of powering the LED fixture 130 using a fraction of the normal power compared to the power required for the standard light fixture. In one exemplary realization, a current of 200 mA, which is significantly lower than the energy requirements of the LED fixture 130 under the Normal State, is drawn from the battery unit 140 to light up the LED fixture 130 during the Emergency State, with the emergency light system 100 still providing enough lumens with this current of 200 mA to efficiently operate as an emergency light.

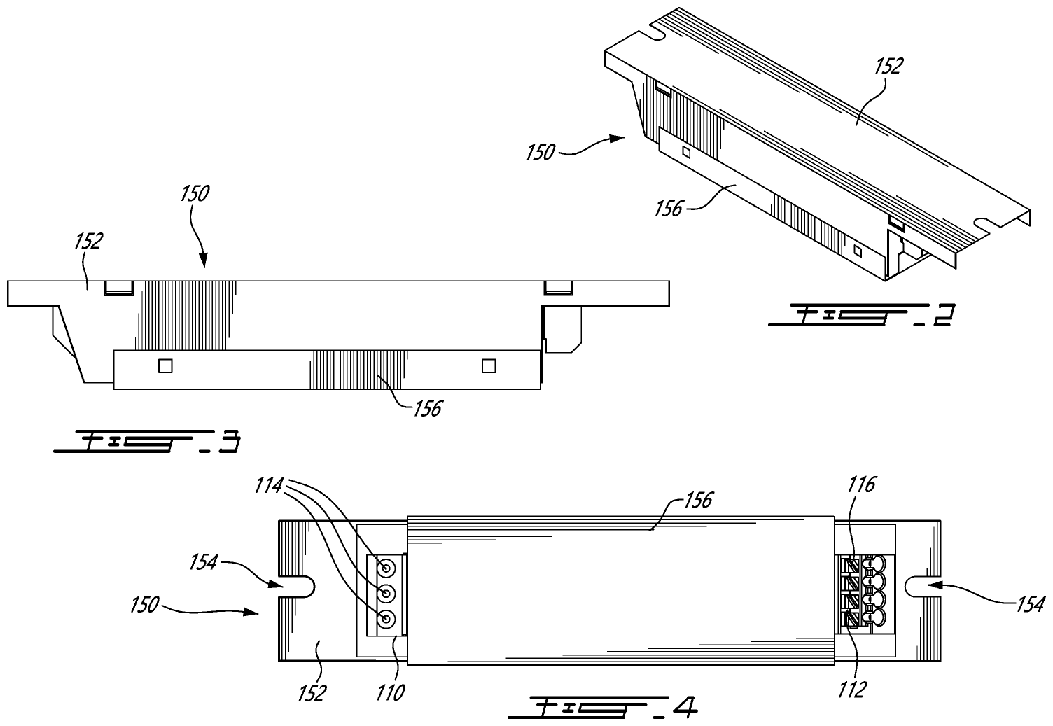

Referring now to FIGS. 2 to 4, the link driver 110 is mounted in a casing 150 designed to be mounted inside the standard light fixture 90. The casing 150 comprises a first casing element 152 including two notches 154 adapted to mount the casing 150 with mounting screws (not shown).

The casing 150 comprises a cover 156, with the casing 150 enclosing entirely the link driver 110 with the exception of the driver connectors 112, the battery connectors 114 and the powering connectors 116.

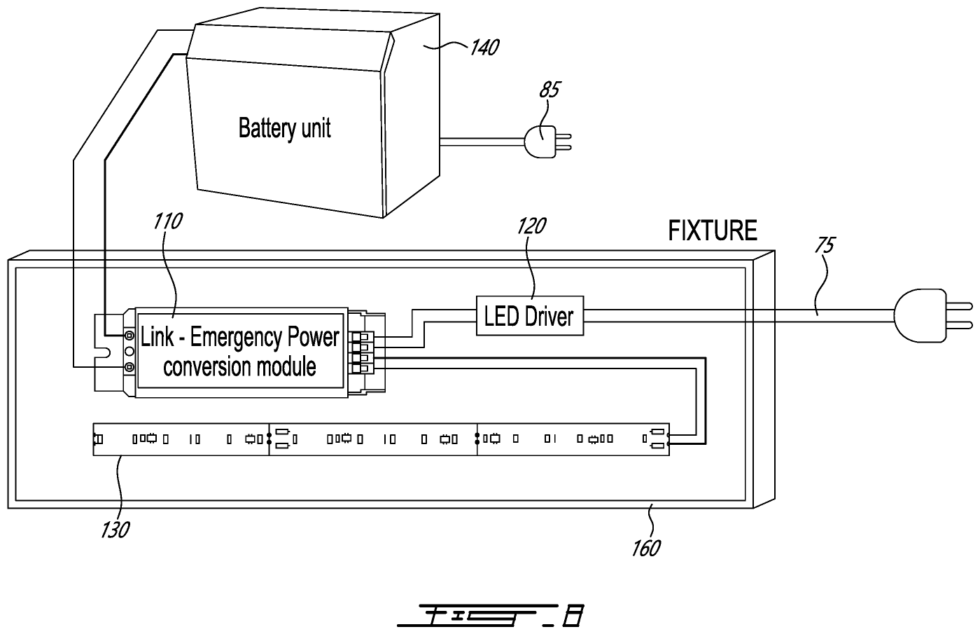

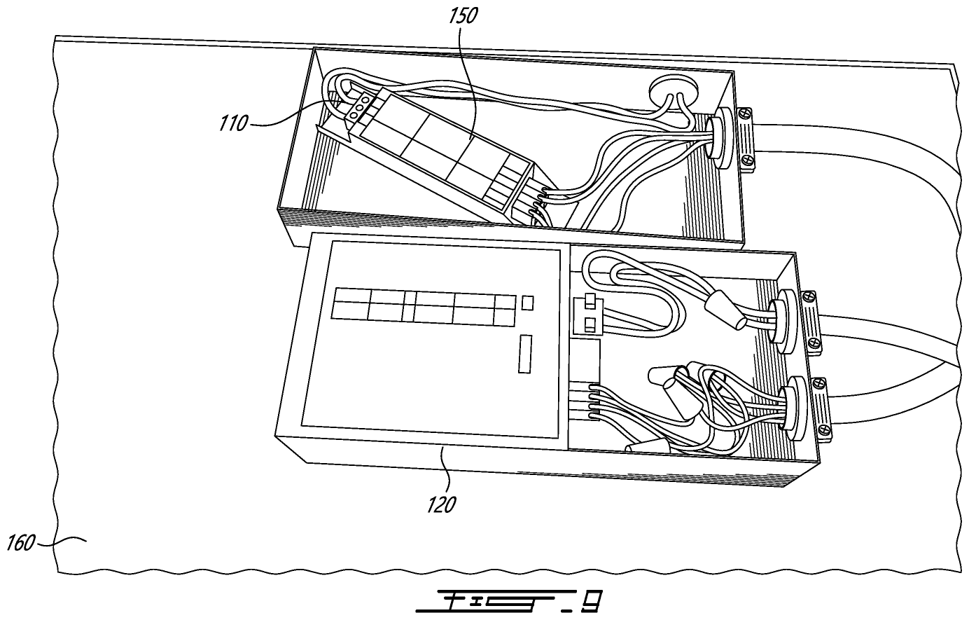

Referring now to FIGS. 8 and 9, according to a first realization, the casing 150 is installed in the standard light fixture 90, when and where the mechanics, aka configuration, of the standard light fixture 90 allow it.

FIG. 8 schematically shows the installation taking place in a fixture casing 160. FIG. 9 is a picture of a portion of the fixture casing 160 with the fixture cover removed, showing the LED driver 120 and the link driver 110 connected one to the other.

According to another realization, when the mechanics of the standard light fixture 90 do not allow the link driver 110 (preferably in the casing 150) to be installed therein, a metallic junction box (not shown) is used to install the link driver 110. The metallic junction box is fixed on the standard light fixture 90 directly or alternatively using, for example, BX cables.

According to one realization, the link driver 110 is installed on the standard light fixture 90 on site.

According to another realization, the link driver 110 is installed on the standard light fixture 90 before installation of the latter. Thus the link driver 110 is installed on the standard light fixture 90 at the manufacturing step, before being sold to the customer.

According to another realization (not shown), the transformer (not shown) converting the AC current from the unswitched AC power source 85 into DC current is located outside the battery unit 140.

Accordingly, the present disclosure contemplates a method of retrofitting into an emergency light system 100 a light fixture assembly 90 comprising a light fixture 130 and a light-fixture driver 120 connected to the light fixture 130. The method comprises: providing a link driver 110; mounting the link driver 110 to the light fixture assembly 90; disconnecting the light-fixture driver 120 from the light fixture assembly 90; connecting the light-fixture driver 120 to the link driver 110; connecting the link driver 110 to the light fixture 130; and connecting a battery unit 140 to the link driver 110. The link driver 110 is adapted to switch from the light-fixture driver 120 powering the light fixture 130 to the battery unit 140 powering the light fixture 130 upon a power outage.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A link driver to be installed in an emergency light system connected to a battery unit, the emergency light system including a light-fixture driver and a light fixture powered by the light-fixture driver, the link driver comprising:
a driver connector adapted to be powered by the light-fixture driver;
a battery connector adapted to be powered by the battery unit, wherein the battery unit is adapted to power the battery connector upon occurrence of a power outage;
a powering connector adapted to be connected to the light fixture; and
an internal transfer device adapted to switch a power source powering the powering connector from the driver connector to the battery connector upon detection of the power outage.

2. The link driver of claim 1, wherein the link driver is adapted to be powered by Direct Current (DC) power sources.

3. The link driver of claim 1, wherein the link driver is adapted to transmit a high-power output when powered by the light-fixture driver and a low-power output upon the detection of the power outage, the high-power output being greater than the low-power output.

4. The link driver of claim 3, wherein the low-power output enables powering the light fixture to a lighting efficiency of at least 10 lux.

5. The link driver of claim 4, wherein the lighting efficiency under low-power output is maintained for at least one of 30 minutes, 2 hours, and 4 hours.

6. The link driver of claim 3, wherein the low-power output enables powering the light fixture to maintain an average lighting efficiency that is equal or over 1 lux over a reference time period of at least 30 minutes.

7. The link driver of claim 3, wherein the low-power output is below one of 20 watts, 15 watts and 12 watts.

8. The link driver of claim 3, wherein the low-power output features a constant current over a reference time period of at least 30 minutes.

9. The link driver of claim 1, comprising a PCB connecting the driver connector, the battery connector, the powering connector, and the internal transfer device.

10. An emergency light system comprising:
a battery unit adapted to transmit power upon occurrence of a power outage;
a light-fixture driver adapted to be powered by a switch-controlled power source;
a light fixture for providing light when powered; and
a link driver comprising:
a driver connector adapted to be powered by the light-fixture driver;
a battery connector adapted to be powered by the battery unit;
a powering connector connected to the light fixture; and
an internal transfer device adapted to switch power source powering the power connector from the driver connector to the battery connectors upon detection of the power outage.

11. The emergency light system of claim 10, wherein the light-fixture driver is adapted to be powered with Alternative Current (AC) and the link driver is adapted to be powered with Direct Current (DC).

12. The emergency light system of claim 10, wherein the link driver is adapted to transmit a high-power output when powered by the switch-controlled power source and a low-power output upon the detection of the power outage.

13. The emergency light system of claim 12, wherein the low-power output is below one of 20 watts, 15 watts and 12 watts.

14. The emergency light system of claim 12, wherein the low-power output features a constant current over a reference time period of at least 30 minutes.

15. The emergency light system of claim 14, wherein the constant current of the low-power output is maintained as long as voltage provided by the battery unit is over a threshold value and the power outage remains.

16. The emergency light system of claim 10, wherein the link driver comprises a PCB connecting the driver connector, the battery connector, the powering connector, and the internal transfer device.

17. The emergency light system of claim 10, wherein the light fixture includes a LED fixture.

18. A method of retrofitting into an emergency light system a light fixture assembly comprising a light fixture and a light-fixture driver connected to the light fixture, the method comprising:
providing a link driver;
mounting the link driver to the light fixture assembly;
disconnecting the light-fixture driver from the light fixture assembly;
connecting the light-fixture driver to the link driver;
connecting the link driver to the light fixture; and
connecting a battery unit to the link driver,
wherein the link driver is adapted to switch from the light-fixture driver powering the light fixture to the battery unit powering the light fixture upon a power outage.

19. The method of claim 18, wherein the link driver is adapted to transmit a high-power output when powered by the light-fixture driver and a low-power output upon the detection of the power outage, the high-power output being greater than the low-power output.

20. The method of claim 18, wherein the light-fixture driver is adapted to be powered with Alternative Current (AC) and the link driver is adapted to be powered with Direct Current (DC).
